(19) United States
(12) Patent Application Publication
(10) Pub. No.: US 2012/0292183 A1
(43) Pub. Date: Nov. 22, 2012

(54) Stand-Alone Water Detection Device That Includes a Hydrogen Source

(76) Inventors: Jessica Thery, Fontaine (FR); Philippe Coronel, Barraux (FR); Vincent Faucheux, Lans en Vercors (FR); Jean-Yves Laurent, Domene (FR)

(21) Appl. No.: 13/575,282

(22) PCT Filed: Jan. 20, 2011
(86) PCT No.: PCT/EP2011/050752

§ 371 Date: Jul. 25, 2012

(30) Foreign Application Priority Data
Jan. 26, 2010 (FR) 10 00284

(51) Int. Cl. G01N 27/411; G01N 27/417

(52) U.S. Cl. 204/407; 204/422; 204/412

(57) ABSTRACT

A water detection device comprising at least one fuel cell comprising a first electrode, a layer of electrolyte, a second electrode and an electrical measurement device characterized in that the first electrode of the cell is in contact with a first face of a porous silicon substrate comprising Si—H bonds, in such a manner as to liberate a flow of hydrogen in the presence of water. Advantageously, the substrate of porous silicon is incorporated into a first housing permeable to water, the fuel cell being incorporated into a second housing said second housing being impermeable to water and permeable to oxygen.

The field of the invention is that of energy-autonomous water detection devices and more precisely relates to water detection devices capable of evaluating a quantity of water and not of only operating in binary mode: presence of water or not as offered in known water detectors.

The majority of water detection devices are not autonomous in energy. The supply of energy takes place via a source internal to the device (power cells) or else via the electrical distribution system. For this reason, the existing devices are not miniaturizable and require means of connections incompatible with spaces of limited size or difficult to access.

However, in the patent application FR 2 906 037, an energy-autonomous water detector of the voltaic cell type has already been described. The electrolyte is composed of a porous material. The porous layer has a coating liberating ionic species. When the electrolyte is in contact with water, ionic conduction takes place via the liberation of ions within the electrolyte and generation of energy via the reactions:

Zn→2e⁻+Zn²⁺

2H₂O+2e⁻→2HO⁻+H₂

This type of detector does not allow the size of the leak to be evaluated. There is no gradation of the signal: in the presence of water, there is a signal, whereas without water, there is no signal. The information is binary. Furthermore, once the zinc electrode has been consumed, the system no longer works.

In this context, the subject of the present invention is a solution consisting in using the presence of water for triggering a reaction that liberates hydrogen which will itself supply a fuel cell which plays the role of supplier of the electrical signal. The interest of such a device resides in the fact that it supplies a signal proportional to a quantity of water.

More precisely, the subject of the present invention is a water detection device comprising at least one fuel cell comprising a first electrode, a layer of electrolyte, a second electrode and an electrical measurement device characterized in that the first electrode of the cell is in contact with a first face of a porous silicon substrate comprising Si—H bonds, in such a manner as to liberate a flow of hydrogen in the presence of water.

According to one variant of the invention, the device furthermore comprises a catalyzer inside of the pores of the silicon substrate promoting the liberation of the flow of hydrogen.

According to one variant of the invention, the catalyzer comprises a material able to liberate hydroxide ions, which material can be of the KOH type.

According to one variant of the invention, the water detection device comprises a first housing permeable to water comprising the porous silicon substrate.

According to one variant of the invention, the water detection device comprises a second housing comprising the fuel cell, said second housing being impermeable to water and permeable to oxygen.

According to one variant of the invention, the water detection device comprises an assembly of elementary cells, each elementary cell comprising at least one elementary fuel cell and one elementary porous silicon substrate.

According to one variant of the invention, the water detection device comprises an assembly of elementary cells comprising porous silicon substrates whose dimensions perpendicular to the plane of the electrodes are distributed according to a gradient in such a manner as to be able to detect various elementary levels of water.

According to one variant of the invention, the water device comprises a common layer of electrolyte, first electrodes and second electrodes being discontinuous on either side of the layer of electrolyte material and a common porous silicon substrate.

According to one variant of the invention, the common layer of electrolyte comprises insulating transverse regions impermeable to protons in such a manner as to partition the latter inside of the elementary cells.

According to one variant of the invention, the water detection device comprises a matrix configuration of elementary water detection cells.

Another subject of the invention is a device for cartography of aqueous regions comprising a water detection device according to the invention, equipped with a device for matrix electrical measurements.

A further subject of the invention is a device for recognition of fingerprints characterized in that it comprises a device for cartography of aqueous regions according to the invention.

The invention will be better understood and other advantages will become apparent upon reading the description that follows, presented by way of non-limiting example and thanks to the appended figures amongst which:

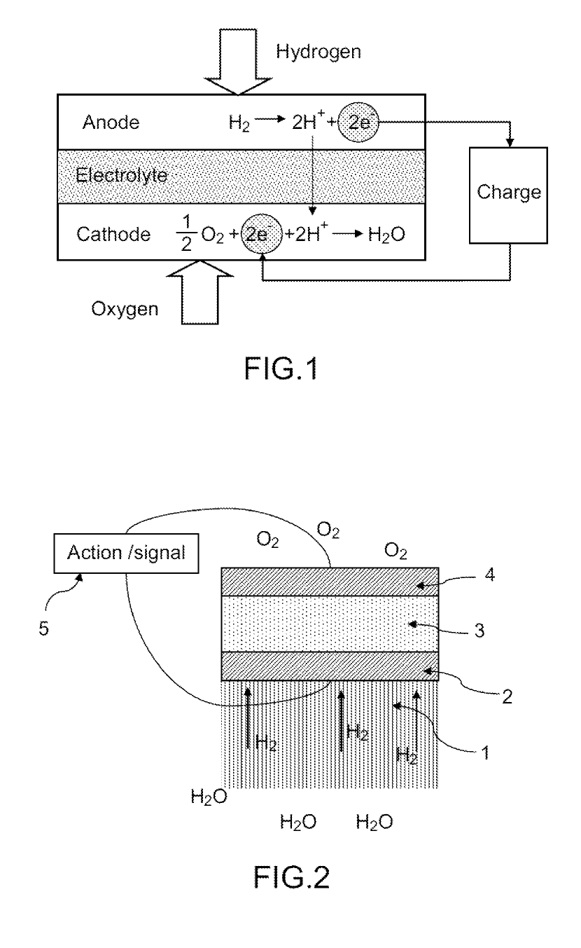

FIG. 1 illustrates the fuel cell principle used in the present invention;

FIG. 2 illustrates a first variant of water detection device according to the invention;

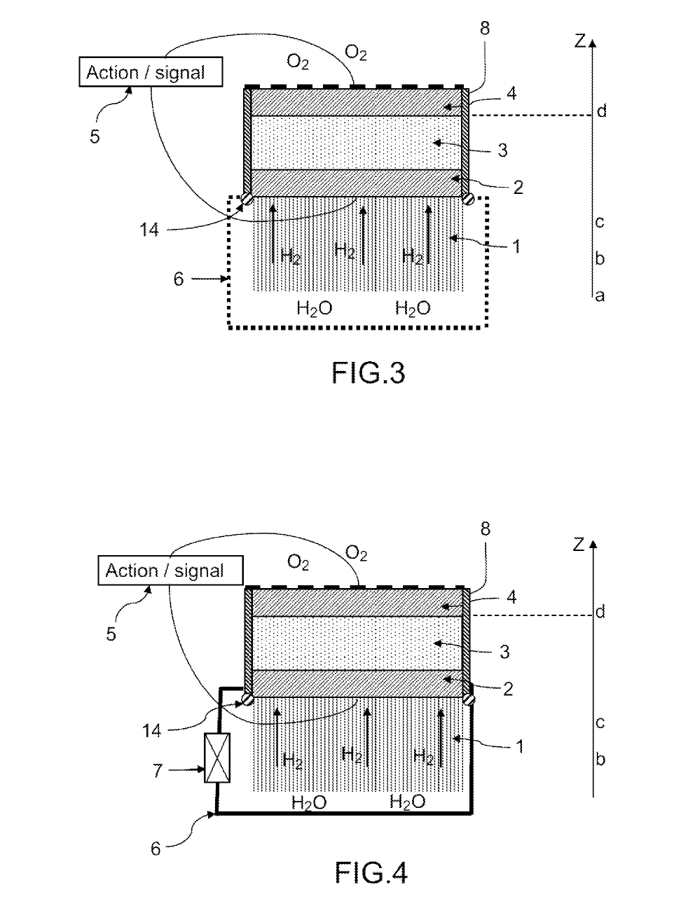

FIG. 3 illustrates a second variant of water detection device according to the invention;

FIG. 4 illustrates a third variant of water detection device according to the invention;

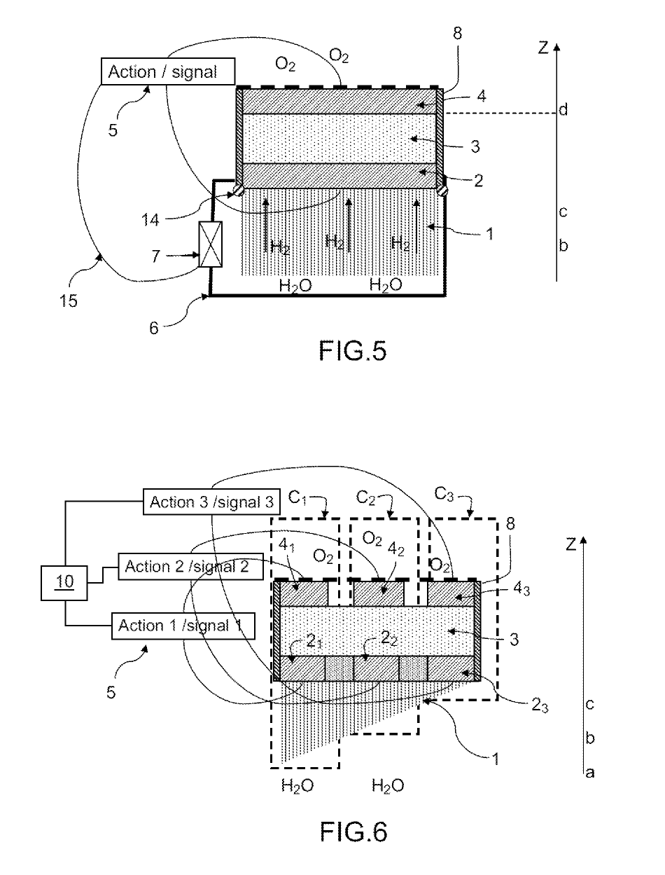

FIG. 5 illustrates an improved embodiment of the variant illustrated in FIG. 4;

FIG. 6 illustrates a water detection device according to the invention comprising elementary detection cells;

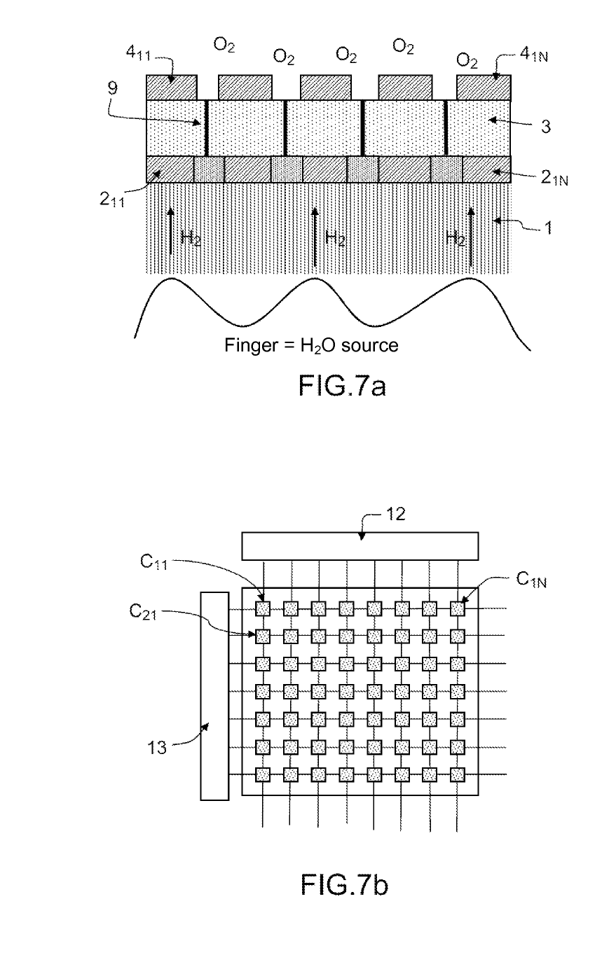

FIGS. 7a and 7b illustrate a device for cartography of aqueous regions according to the invention that can advantageously be used in a device for the identification of fingerprints.

In a general manner, the fuel cell principle used in the present invention is illustrated in FIG. 1. An anode electrode, permeable to hydrogen, is the seat of the following reaction:

H₂→2H⁺+2e⁻

An electrolytic material provides the transport of protons to a cathode, seat of the following reaction by supply of oxygen present in the air and supply of electrons:

½O₂+2e⁻+2H⁺→H₂O

The general principle of operation of the water detector of the invention can thus be illustrated by the following block diagram:

In the presence of a given volume of water, the detector generates a volume of hydrogen proportional to the volume of water. The detector simultaneously generates a signal of intensity proportional to the volume of hydrogen.

FIG. 2 illustrates a first variant of a water detector according to the invention. The detector comprises a substrate 1 made of porous silicon. This porous silicon comprises bonds of the Si—H type. The pores traverse the porous silicon. Advantageously, the pores of the silicium can comprise a catalyzer (not shown) which can be formed by a coating liberating hydroxide ions in the presence of water; typically, this coating can be caustic potash. The catalyzer may also be contained within the aqueous solution to be detected.

In the presence of water, hydrogen is liberated via the following chemical reaction:

Si—Si—H+4H₂O→Si(OH)₄+2H₂+Si—H

The hydrogen migrates through the pores of the porous silicon to arrive at the electrode 2. The electrode 2 corresponds to an active electrode, electron-conducting and active with respect to the reaction:

H₂→2H⁺2e⁻

The layer 3 is a layer providing a function of electrolyte; it advantageously consists of a proton-conducting membrane.

The electrode 4 is an electron-conducting electrode which catalyzes the reaction:

½O₂+2e⁻+2H⁺→H₂O

Consequently, in the presence of water, hydrogen is generated and the fuel cell goes into an active state. There is a voltage U in the range between 0V and 1.1V between the electrodes 2 and 4.

The cell can then power an electrical measurement device 5 that can advantageously incorporate an alarm or action device. The device 5 can comprise a controller, which allows the operating voltage to be fixed, and an alarm (audio or visual) and/or an actuator.

It is also possible to add, within the device 5, a capacitive system or batteries so as to store the energy supplied by the cell, in order to power the alarm or the actuator. The controller can first of all charge the battery, or the capacitor, then analyze the variation in the current intensity produced by the cell as a function of time. Since the current intensity is correlated to the flow of hydrogen, this accordingly allows the flow of water to be deduced.

FIG. 3 illustrates a second variant of the invention in which the detector is integrated into a first housing 6 permeable to water. The hydrogen is naturally directed toward the electrode 2 in the presence of water. When the level of water decreases, the hydrogen formed is evacuated via the leak-tight housing. On the cathode side, the presence of a second hydrophobic housing 8 impermeable to water, but which allows oxygen to pass, prevents the electrode from being inundated if the level of water exceeds the level Z=d. The housing 8 may also be a porous hydrophobic coating. The housing 6 and the porous silicon are rigidly attached. Once the porous silicon has been consumed, the system can be recharged by disconnecting the assembly 1+6 at the fastening elements 14 provided for this purpose and by connecting a new assembly 1+6 here.

For safety reasons, in the case of production of hydrogen at a flow greater than 1 sccm (corresponding to a standard unit in cm³/minute), the housing 6 may also be a leak-tight housing equipped with a leak-tight anti-return valve 7 as illustrated in a third variant shown in FIG. 4, which allows liquid water to pass, but does not allow the hydrogen to pass.

In an improved embodiment illustrated in FIG. 5, the anti-return valve 7 can also be controlled by the actuator 5 in an anticipated manner, via a connection 15.

### First Exemplary Embodiment of a Water Detector According to the Invention

The detection device comprises several elementary cells. FIG. 6 thus shows, by way of example, an assembly of three cells C₁, C₂, C₃ comprising fuel cells formed via a common layer of electrolyte. Discontinuous electrodes 2₁, 2₂, 2₃ are provided for this purpose together with discontinuous electrodes 4₁, 4₂, 4₃. In this way, the detector can be used to evaluate for example a level of water as shown in FIG. 6. If the level of water is in the range between a level a and a level b, a potential difference U appears across the terminals of the cell 1 and a current I is generated which generates an action 1 (or a signal 1).

If the level of water is in the range between the level b and a level c, the cell C₂ is activated and generates the signal 2/action 2 in parallel with the cell C₁ also activated.

If the level is greater than the level c, the cell C₃ is activated and generates the signal 3/action 3, in parallel with the cells C₁ and C₂ also activated, . . . etc. . . . up to n cells (not shown).

The system 10 thus allows the dynamic variation of the level of water to be monitored.

### Second Exemplary Embodiment of a Water Detection Device According to the Invention

The detection system comprises several elementary cells comprising fuel cells, organized in a matrix fashion. This system allows the detection of an “image” of the water: it may be used, for example, in the framework of the detection of fingerprints.

The system provides an image of the shape of the fingerprint based on the variations of water produced by the peaks and the troughs of a finger. FIG. 7a shows a top view of the device, FIG. 7b illustrating a schematic view highlighting the matrix configuration and the processing circuits.

FIG. 7a highlights, on one row of the matrix configuration, the common layer of electrolyte 3 comprising ionic non-conducting regions 9 allowing the elementary cells to be sealed from one another. An assembly of electrodes 2₁₁, . . . , 2_{1N} and of electrodes 4₁₁, . . . , 4_{1N} allow the fuel cells of the first row of elementary cells C₁₁, . . . , C_{1N} of the detector to be formed.

In the present case of a detector composed of an arrangement of several cells, in order to prevent the interference associated with the proximity of two cells, the membrane may be discontinuous or rendered ionic non-conducting within the regions 9.

The lateral dimension of a cell is in the range between 10 nm and 10 cm. Preferably, the size of a cell is in the range between 0.1 μm and 1000 μm. The space between the cells is preferably in the range between 0.1 and 50 μm.

When the imaging system is brought into contact with the pixellized detector, the cells in contact with the regions of water (or aqueous) are activated. “Activated” is understood to mean that there is a potential difference U in the range between 0 and 1.1 V across the terminals of the cell, preferably in the range between 0.5 and 1.1 V, and generation of a current I. Reading of the activated cells is carried out via a matrix addressing. The circuit 12 allows the column electrode to be selected, and the circuit 13 allows the row electrode to be selected.

The information U allows it to be known whether the cell is in contact with water and hence the cartography of the water of the objet in contact with the detector to be defined. The information I allows the quantity of water to be deduced.

The electrodes are made from an electron-conducting and catalytic material. They are composed of platinum Pt, or of an alloy containing platinum, for example of the type platinum/ruthenium, palladium or again gold, carbon or else of an assembly of the aforementioned elements.

The components of the electrodes 2 may be different from or identical to the components of the electrodes 4.

The electrolyte 3 is a proton-conducting compound. This compound can be a polymer of the fluorocarbon type functionalized with acid groupings of the —COOH, —SO₃H or —PO(OH)₂ type. The compound may also be a carbon polymer functionalized with the aforementioned acid groupings. The electrolyte 3 is preferably Nafion® or another polymer derived from Nafion®. The material currently most widely used for the ion-exchange membrane is indeed Nafion manufactured by Dupont of Nemours. This is a co-polymer with a perfluorinated structure (of the Teflon type) onto which sulfonate SO₃⁻ groupings are grafted. Its thickness is of the order of 50 to 150 μm. In order to ensure the migration of the protons, thanks to a good ionic conductivity, the membrane must be hydrated.

Preferably, the thickness of electrolyte separating the first and second electrodes is in the range between 0.1 μm and 100 μm and more particularly between 1 nm to 1000 nm.

In order to form a hydrogenated porous silicon substrate, a hydrogenation can advantageously be effected by electrochemical treatment with an acid of a doped silicon substrate. The size of the pores is preferably in the range between 1 nm and 100 nm.

When a catalyzer is employed, the substance liberating hydroxide ions upon contact with water is incorporated into the porous silicon 1. Another solution is to use a coating liberating hydroxide ions localized in the housing 6.

Thus, according to the invention, in the presence of water, the cell or the fuel cells is or are active: the voltage of the cell or cells is in the range between 0 and 1.1 V.

Preferably, for charging the battery or the capacitor, the voltage is in the range between 1.1 and 0.4 V. For the study of the variation of the intensity as a function of time, the voltage is set in the range between 0 and 1.1 V and preferably at a voltage in the range between 0 and 0.5 V.

1. A water detection device comprising at least one fuel cell comprising a first electrode, a layer of electrolyte, a second electrode and an electrical measurement device wherein the first electrode of the cell is in contact with a first face of a porous silicon substrate comprising Si—H bonds, in such a manner as to liberate a flow of hydrogen in the presence of water.

2. The water detection device as claimed in claim 1, further comprising a catalyzer inside of the pores of the silicon substrate promoting the liberation of the flow of hydrogen.

3. The water detection device as claimed in claim 2, wherein the catalyzer comprises a material able to liberate hydroxide ions, which can be of the KOH type.

4. The water detection device as claimed in claim 1 further comprising a first housing permeable to water comprising the porous silicon substrate.

5. The water detection device as claimed in claim 1, further comprising a second housing comprising the fuel cell, said second housing being impermeable to water and permeable to oxygen.

6. The water detection device as claimed in claim 1, further comprising an assembly of elementary cells, each elementary cell comprising at least one elementary fuel cell and one elementary porous silicon substrate.

7. The water detection device as claimed in claim 6, further comprising an assembly of elementary cells comprising porous silicon substrates whose dimensions perpendicular to the plane of the electrodes are distributed according to a gradient in such a manner as to be able to detect various elementary levels of water.

8. The water detection device as claimed in claim 6, further comprising a common layer of electrolyte, first electrodes and second electrodes being discontinuous on either side of the layer of electrolyte material and a common porous silicon substrate.

9. The water detection device as claimed in claim 8, wherein the common layer comprises insulating transverse regions impermeable to protons in such a manner as to partition the latter inside of the elementary cells.

10. The water detection device as claimed in claim 6, further comprising a matrix configuration of elementary water detection cells.

11. A device for cartography of aqueous regions comprising a water detection device as claimed in claim 10, equipped with a device for matrix electrical measurements.

12. A fingerprint identification device comprising a device for cartography of aqueous regions as claimed in claim 11.
